(19) United States
(12) Patent Application Publication
(10) Pub. No.: US 2008/0134228 A1
(43) Pub. Date: Jun. 5, 2008

(54) Customer Loyalty Based System Internet Protocol Television Advertising Mechanism

(75) Inventors: Gino Dion, Embrun (CA); Derek Kuhn, Ottawa (CA); Jeff Furlong, Grand Bay - Westfield (CA)

Correspondence Address: ALCATEL LUCENT;INTELLECTUAL PROPERTY & STANDARDS, 3400 W. PLANO PARKWAY, MS LEGL2, PLANO, TX, 75075, US

(73) Assignee: ALCATEL, Paris (FR)

(21) Appl. No.: 11/565,570

(22) Filed: Nov. 30, 2006

(51) Int. Cl. H04H 60/32

(52) U.S. Cl. 725/20

(57) ABSTRACT

A system, method, and computer readable medium for customer loyalty based Internet Protocol television advertising, comprises, recording a viewership of a viewed advertisement, collecting a view time of the viewed advertisement, and crediting a viewer with having viewed the advertisement.

### BACKGROUND OF THE INVENTION

The present invention is generally related to advertisement viewership tracking and, more specifically to a customer loyalty based system internet protocol television advertising mechanism.

Currently, various loyalty based systems reward users for watching Video On Demand (VOD) based content and various video recorders provides end-user tools to manage and select specific advertisements to be viewed. However, none of these solutions track real-time viewing of advertisements within an Internet Protocol Television (IPTV) broadcast delivery platform.

Therefore, what is needed is an environment that would reward IPTV users, in exchange for watching regularly inserted advertisements broadcasted within an IPTV media delivery platform.

### SUMMARY OF THE INVENTION

The present invention tracks the viewing of advertisements by the end-user and provides credits to his account. This is tracked within the IPTV client code on the end-user STB (Set-top-Box). These credits could be exchanged by the end-user for a variety of products and services offered by the service provider, such as free VOD purchases, better Internet speeds (higher tier) and free cell phone minutes.

The present invention requires no end-user interaction (except for the actual viewing of the advertisements and rewards users for watching regular advertisements that would otherwise often be skipped, skimmed through, or not watched because of a channel change. This provides tremendous value to service providers.

The present invention is a client residing on the STB that would track when advertisements are playing within a broadcast channel. It does so by parsing the Real-Time Transport Protocol (RTP)/Internet Protocol (IP) encapsulation for a specific byte code signal, inserted earlier by the IPTV encoders at the head-end.

Upon viewing an advertisement, the invention notifies a centralized server of the specific advertisement, combined with a timestamp, and then end-user ID, to create a token. This token would then constitute a viewed advertisement credit. Tokens can be of various value, based upon advertiser criteria such as an advertisement during a prime-time show could have more value then an advertisement for a lesser viewed channel. The present invention operates within an IPTV broadcast delivery platform.

In one embodiment of the present invention, a method for customer loyalty based Internet Protocol television advertising, comprises, recording a viewership of a viewed advertisement, collecting a view time of the viewed advertisement, and crediting a viewer with having viewed the advertisement. The method may comprise parsing an incoming data stream for an advertisement byte code signal, tracking the viewed advertisement by a predetermined byte code signal and determining a viewer identification. The method may also comprise sending the viewer identification to an interested party, sending the recorded viewership to an interested party and sending the collected view time to an interested party. Wherein the recorded viewership is recorded in a set top box, the recorded viewership is recorded in a remote location and the crediting is by means of a token.

In a further embodiment of the present invention, a computer readable medium comprises instructions for, receiving a viewer identification, receiving a recorded viewership of an advertisement, receiving a collected view time of the advertisement, and crediting a viewer with having viewed the advertisement. The computer readable medium may also comprise recording internet sites visited by the viewer and correlating the recorded internet sites to the recorded viewership of the advertisement. The computer readable medium may additionally comprise recording internet purchases by the viewer, correlating the recorded internet purchases to the recorded viewership of the advertisement, determining an advertising efficiency based upon the correlation of recorded internet purchases to the recorded viewership of the advertisement and adjusting the crediting of the viewer with having viewed the advertisement based upon criteria pre-determined by an advertiser.

In yet a further embodiment, a system of customer loyalty based Internet Protocol television advertising, comprises, a memory that receives at least one of, a viewer identification, a viewership of an advertisement, and a view time of the viewed advertisement, and a processor communicably coupled to the memory, wherein the processor, sends the viewer identification to an interested party, sends the viewership of the advertisement to the interested party, and sends the view time of the advertisement to the interested party. The processor may receive credit confirmation for viewing the advertisement and send a viewership statistics to the interested party.

### BRIEF DESCRIPTION OF THE DRAWINGS

FIG. 1 illustrates an IPTV system overview;

FIG. 2 illustrates a first method flow diagram listing the steps of a method of operation of an embodiment of the present invention;

FIG. 3 illustrates a second method flow diagram listing the steps of a method of operation of an embodiment of the present invention;

FIG. 4 illustrates a first software flow diagram in accordance with a preferred embodiment of the present invention;

FIG. 5 illustrates a second software flow diagram in accordance with an embodiment of the present invention;

FIG. 6 illustrates a first system of customer loyalty based Internet Protocol television advertising in accordance with an embodiment of the present invention; and

FIG. 7 illustrates a second system of customer loyalty based Internet Protocol television advertising in accordance with an embodiment of the present invention.

### DETAILED DESCRIPTION OF THE INVENTION

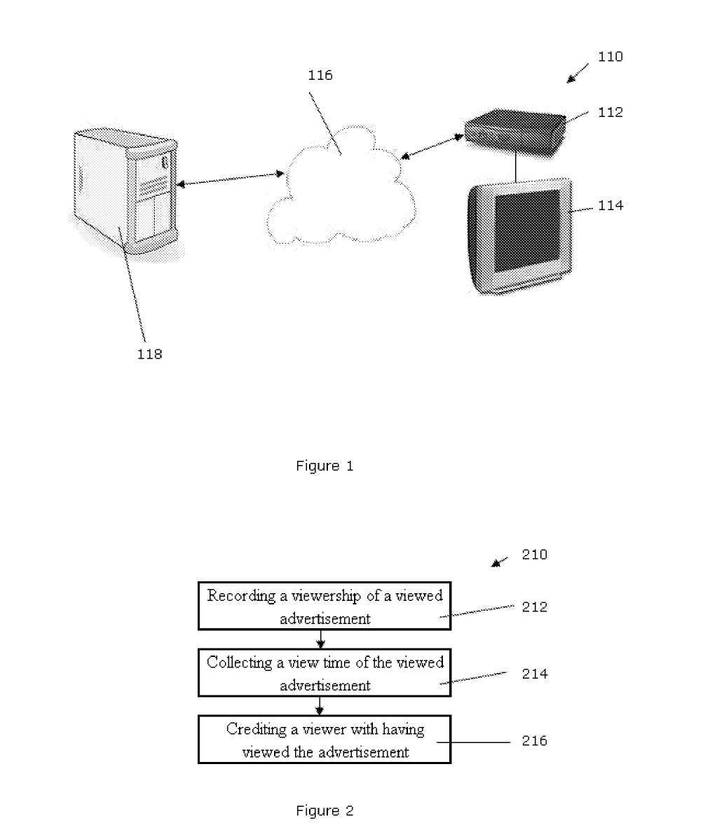

Referring now to FIG. 1, depicts an IPTV system 110. The system has a set top box 112 connected to a television 114. The STB records which advertisements are viewed and sends a report by means of the network 116 to an interested party 118, which could include an advertiser.

Referring now to FIG. 2, a first method of customer loyalty based IPTV advertising 210 is depicted and comprises a number of blocks or modules that are software, hardware, or firmware, and/or the combination of software, hardware, and/or firmware. The method comprises recording 212 a viewership of a viewed advertisement, collecting 214 a view time of the viewed advertisement, and crediting 216 a viewer with having viewed the advertisement. The transfer of information between the modules occurs via at least one of: a wireless protocol, a wired protocol and a combination of the wireless protocol and the wired protocol.

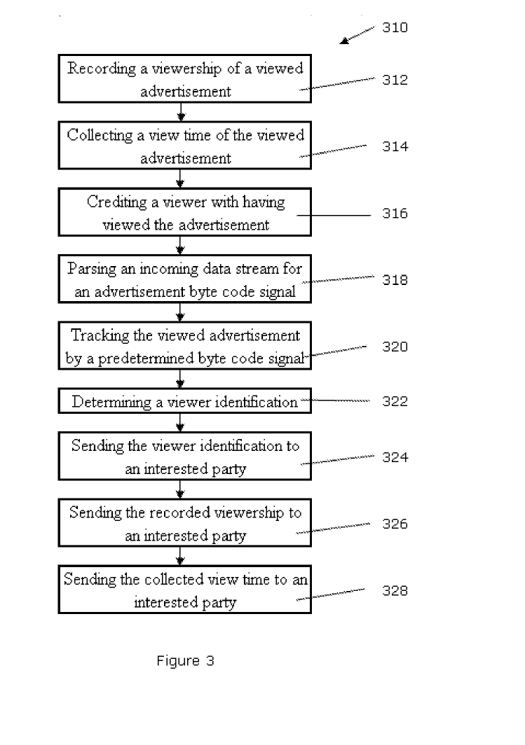

Referring now to FIG. 3, a second method of customer loyalty based IPTV advertising 310 is depicted and comprises a number of blocks or modules that are software, hardware, or firmware, and/or the combination of software, hardware, and/or firmware. The method comprises recording 312 a viewership of a viewed advertisement, collecting 314 a view time of the viewed advertisement, and crediting 316 a viewer with having viewed the advertisement. The method may comprise parsing 318 an incoming data stream for an advertisement byte code signal, tracking 320 the viewed advertisement by a predetermined byte code signal and determining a viewer identification. The method may also comprise sending 324 the viewer identification to an interested party, sending 326 the recorded viewership to an interested party and sending 328 the collected view time to an interested party, wherein the recorded viewership is recorded in a set top box, the recorded viewership is recorded in a remote location and the crediting is by means of a token. The transfer of information between the modules occurs via at least one of: a wireless protocol, a wired protocol and a combination of the wireless protocol and the wired protocol.

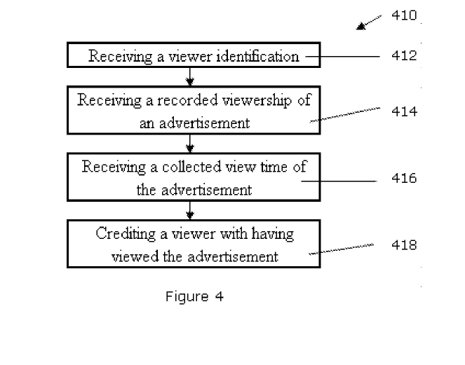

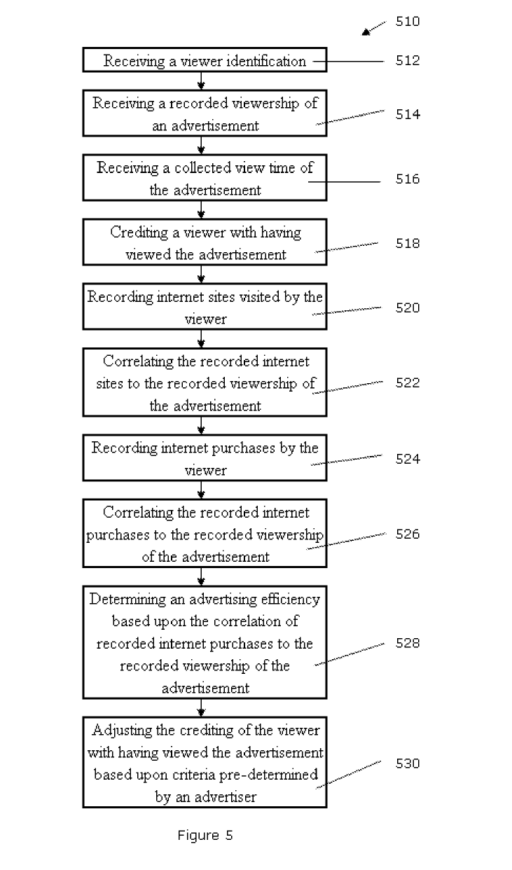

Referring now to FIG. 4, a first software flow block 410 of customer loyalty based IPTV advertising is depicted. A computer readable medium, or software, comprises instructions for, receiving 412 a viewer identification, receiving 414 a recorded viewership of an advertisement, receiving 416 a collected view time of the advertisement, and crediting 418 a viewer with having viewed the advertisement. These steps are preferably embodied in a computer readable medium or software but may also be embodied in firmware and are utilized via hardware. The transfer of information occurs via at least one of a wireless protocol, a wired protocol and the combination of the wireless protocol and the wired protocol. The steps performed in this figure are performed by software, hardware, firmware, and/or the combination of software, hardware, and/or firmware.

Referring now to FIG. 5, a second software flow block 510 of customer loyalty based IPTV advertising is depicted. A computer readable medium, or software, comprises instructions for, receiving 512 a viewer identification, receiving 514 a recorded viewership of an advertisement, receiving 516 a collected view time of the advertisement, and crediting 518 a viewer with having viewed the advertisement. The computer readable medium may also comprise recording 520 internet sites visited by the viewer and correlating 522 the recorded internet sites to the recorded viewership of the advertisement. The computer readable medium may additionally comprise recording 524 internet purchases by the viewer, correlating 526 the recorded internet purchases to the recorded viewership of the advertisement, determining 528 an advertising efficiency based upon the correlation of recorded internet purchases to the recorded viewership of the advertisement and adjusting 530 the crediting of the viewer with having viewed the advertisement based upon criteria pre-determined by an advertiser. These steps are preferably embodied in a computer readable medium or software but may also be embodied in firmware and are utilized via hardware. The transfer of information occurs via at least one of a wireless protocol, a wired protocol and the combination of the wireless protocol and the wired protocol. The steps performed in this figure are performed by software, hardware, firmware, and/or the combination of software, hardware, and/or firmware.

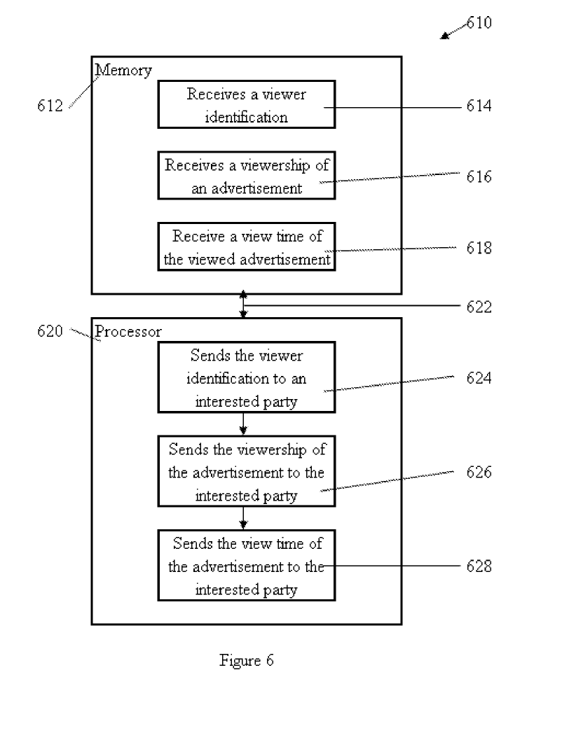

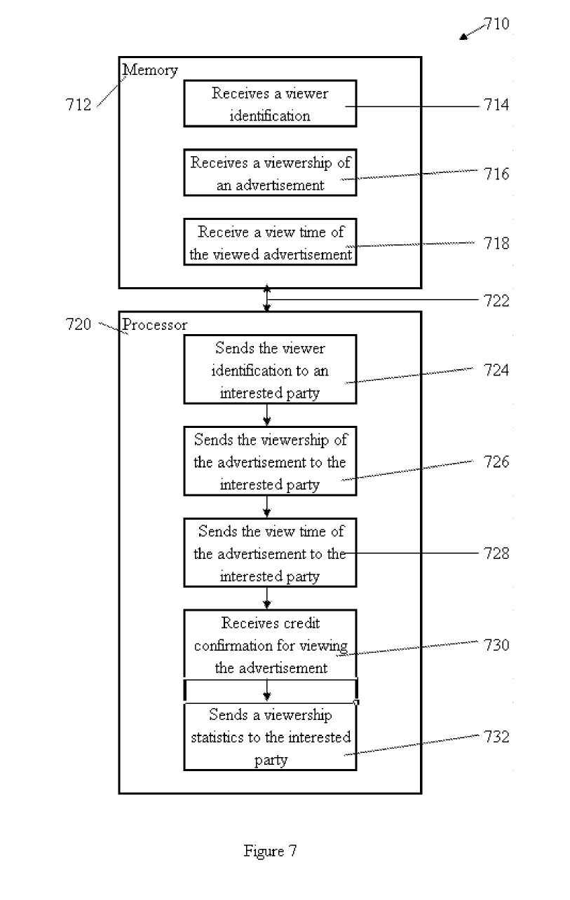

Referring now to FIG. 6, a second system 610 of customer loyalty based internet IPTV advertising is depicted. The system comprises, a memory 612 that receives at least one of, a viewer identification 614, a viewership 616 of an advertisement, and a view time 618 of the viewed advertisement, and a processor 620 communicably coupled 622 to the memory, wherein the processor, sends 624 the viewer identification to an interested party, sends 626 the viewership of the advertisement to the interested party, and sends 628 the view time of the advertisement to the interested party. The transfer of information between the processor and the memory occurs via at least one of a wireless protocol, a wired protocol and a combination of a wireless protocol and a wired protocol. The steps performed in this figure are performed by software, hardware, firmware, and/or the combination of software, hardware, and/or firmware. Additionally, the processor and/or memory described herein form a circuit.

Referring now to FIG. 7, a third system 710 of customer loyalty based IPTV advertising is depicted. The system comprises, a memory 712 that receives at least one of, a viewer identification 714, a viewership 716 of an advertisement, and a view time 718 of the viewed advertisement, and a processor 720 communicably coupled 722 to the memory, wherein the processor, sends 724 the viewer identification to an interested party, sends 726 the viewership of the advertisement to the interested party, and sends 728 the view time of the advertisement to the interested party. The processor may receive 730 credit confirmation for viewing the advertisement and send 732 a viewership statistics to the interested party. The transfer of information between the processor and the memory occurs via at least one of a wireless protocol, a wired protocol and a combination of a wireless protocol and a wired protocol. The steps performed in this figure are performed by software, hardware, firmware, and/or the combination of software, hardware, and/or firmware. Additionally, the processor and/or memory described herein form a circuit.

Although an exemplary embodiment of the system of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A method for customer loyalty based Internet Protocol television advertising, comprising:
recording a viewership of a viewed advertisement;
collecting a view time of the viewed advertisement; and
crediting a viewer with having viewed the advertisement.

2. The method of claim 1 comprising:
parsing an incoming data stream for an advertisement byte code signal.

3. The method of claim 1 comprising:
tracking the viewed advertisement by a predetermined byte code signal.

4. The method of claim 1 comprising:
determining a viewer identification.

5. The method of claim 4 comprising:
sending the viewer identification to an interested party.

6. The method of claim 1 comprising:
sending the recorded viewership to an interested party.

7. The method of claim 1 comprising:
sending the collected view time to an interested party.

8. The method of claim 1 wherein:
the recorded viewership is recorded in a set top box.

9. The method of claim 1 wherein:
the recorded viewership is recorded in a remote location.

10. The method of claim 1 wherein:
the crediting is by means of a token.

11. A computer readable medium comprising instructions for:
receiving a viewer identification;
receiving a recorded viewership of an advertisement;
receiving a collected view time of the advertisement; and
crediting a viewer with having viewed the advertisement.

12. The computer readable medium of claim 11 comprising instructions for:
recording internet sites visited by the viewer.

13. The computer readable medium of claim 12 comprising instructions for:
correlating the recorded internet sites to the recorded viewership of the advertisement.

14. The computer readable medium of claim 11 comprising instructions for:
recording internet purchases by the viewer.

15. The computer readable medium of claim 14 comprising instructions for:
correlating the recorded internet purchases to the recorded viewership of the advertisement.

16. The computer readable medium of claim 15 comprising instructions for:
determining an advertising efficiency based upon the correlation of recorded internet purchases to the recorded viewership of the advertisement.

17. The computer readable medium of claim 11 comprising instructions for:
adjusting the crediting of the viewer with having viewed the advertisement based upon criteria pre-determined by an advertiser.

18. A system of customer loyalty based Internet Protocol television advertising, comprising:
a memory that receives at least one of: a viewer identification, a viewership of an advertisement, and a view time of the viewed advertisement; and
a processor communicably coupled to the memory, wherein the processor:
sends the viewer identification to an interested party;
sends the viewership of the advertisement to the interested party; and
sends the view time of the advertisement to the interested party.

19. The system of claim 18 wherein the processor:
receives credit confirmation for viewing the advertisement.

20. The system of claim 18 wherein the processor:
sends a viewership statistics to the interested party.
